(19) United States
(12) Patent Application Publication
(10) Pub. No.: US 2025/0203462 A1
(43) Pub. Date: Jun. 19, 2025

(54) DISTRIBUTED EVALUATION OF UNESTABLISHED FREQUENCY SPECTRUM FOR OPTIMIZING NETWORK CAPACITY

(71) Applicant: Charter Communications Operating, LLC, St. Louis, MO (US)

(72) Inventors: Roger Graham Stafford, Thornton, CO (US); Justin Stiles, Thornton, CO (US); Jay T. Liew, Parker, CO (US)

(21) Appl. No.: 18/540,370

(22) Filed: Dec. 14, 2023

(51) Int. Cl. H04W 28/20; H04L 5/00; H04W 48/20; H04W 72/0453

(52) U.S. Cl. CPC H04W 28/20; H04L 5/0048; H04W 48/20; H04W 72/0453

(57) ABSTRACT

Configuration of a candidate channel for a network node is caused. The candidate channel comprises a frequency band within an unestablished region of frequency spectrum with unknown modulation support from endpoint devices. A plurality of signal measurements for the candidate channel are received. Each of the plurality of signal measurements is generated by a corresponding endpoint device of a plurality of endpoint devices assigned to the network node. Based at least in part on the plurality of signal measurements, channel viability information is generated indicating whether the candidate channel is viable for each of the endpoint devices. The candidate channel is identified as a viable channel based on the channel viability information.

### BACKGROUND

Modern telecommunications standards enable high-bandwidth data transfer over Cable Television systems (CATV). For example, telecommunications standards such as Data Over Cable Service Interface Specification (DOCSIS) 3.1 enables the use of multiple Orthogonal Frequency Division Multiplexing (OFDM) channels to carry data in established regions of frequency spectrum. Some regions of frequency spectrum are known to support a required level of modulation, such as Orthogonal Frequency-Division Multiple Access (OFDMA), 16K-Quadrature Amplitude Modulation (16K-QAM), 4K-QAM, or lower. Generally, data transfer is carried out over channels that utilize a known region of spectrum that is known to be supported by endpoint devices (e.g., modems, etc.).

### SUMMARY

Implementations of the present disclosure propose an approach to efficiently and effectively identify candidate channels within the unestablished region of frequency spectrum using channel sounding. In this manner, implementations described herein can substantially increase the throughput of existing networks by increasing the number of established channels available.

In one implementation, a method is provided. The method includes causing, by a computing system comprising one or more processor devices, configuration of a candidate channel for a network node, wherein the candidate channel comprises a frequency band within an unestablished region of frequency spectrum with unknown modulation support from endpoint devices. The method includes receiving, by the computing system, a plurality of signal measurements for the candidate channel, wherein each of the plurality of signal measurements is generated by a corresponding endpoint device of a plurality of endpoint devices assigned to the network node. The method includes, based at least in part on the plurality of signal measurements, generating, by the computing system, channel viability information indicating whether the candidate channel is viable for each of the endpoint devices. The method includes identifying, by the computing system, the candidate channel as a viable channel based on the channel viability information.

In another implementation, a network node is provided. The network node includes a memory and one or more processor devices coupled to the memory. The one or more processor devices are configured to configure a candidate channel that comprises a frequency band within an unestablished region of frequency spectrum with unknown modulation support from endpoint devices, wherein the network node is configured with a plurality of established channels, each comprising a frequency band within an established region of the frequency spectrum. The one or more processor devices are configured to receive, from a plurality of endpoint devices assigned to the network node, a plurality of signal measurements for the candidate channel, wherein each of the plurality of signal measurements is generated by a corresponding endpoint device of the plurality of endpoint devices. The one or more processor devices are configured to provide the plurality of signal measurements to a network computing system. The one or more processor devices are configured to, responsive to providing the plurality of signal measurements, receive, from the network computing system, channel configuration information that defines the candidate channel as an established channel comprising a frequency band within the established region of the frequency spectrum.

In another implementation, a non-transitory computer-readable storage medium is provided. The non-transitory computer-readable storage medium includes executable instructions to cause one or more processor devices of a computing system to cause configuration of a candidate channel for a network node, wherein the candidate channel comprises a frequency band within an unestablished region of frequency spectrum with unknown modulation support from endpoint devices. The non-transitory computer-readable storage medium includes executable instructions to cause one or more processor devices of a computing system to receive a plurality of signal measurements for the candidate channel, wherein each of the plurality of signal measurements is generated by a corresponding endpoint device of a plurality of endpoint devices assigned to the network node. The non-transitory computer-readable storage medium includes executable instructions to cause one or more processor devices of a computing system to, based at least in part on the plurality of signal measurements, generate channel viability information indicating whether the candidate channel is viable for each of the endpoint devices. The non-transitory computer-readable storage medium includes executable instructions to cause one or more processor devices of a computing system to identify the candidate channel as a viable channel based on the channel viability information.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for implementing evaluation of unestablished regions of frequency spectrum to increase network throughput according to some implementations of the present disclosure.

FIG. 2 illustrates example signal measurement information according to some implementations of the present disclosure.

FIG. 3 is a flowchart of a method for distributed evaluation of unestablished frequency spectrum for optimizing network capacity according to some implementations of the present disclosure.

FIG. 4 is a flowchart for a method for sequentially evaluating portions of an unestablished region of frequency spectrum to fully evaluate the unestablished region of frequency spectrum according to some implementations of the present disclosure.

FIG. 5 is a block diagram of the network entity suitable for implementing examples according to one implementation.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Modern telecommunications standards enable high-bandwidth data transfer over cable television systems (CATV). For example, telecommunications standards such as Data Over Cable Service Interface Specification (DOCSIS) 3.1 enables the use of multiple Orthogonal Frequency Division Multiplexing (OFDM) channels to carry data in established regions of frequency spectrum. Some regions of frequency spectrum are known to support a required level of modulation, such as 4K-Quadrature Amplitude Modulation (4K-QAM), or lower. Generally, data transfer is carried out over channels that utilize a known region of spectrum that is known to be supported by endpoint devices (e.g., modems, etc.).

In particular, DOCSIS 3.1 enables the use of multiple OFDM channels via a wide range of frequency spectrum, with channel widths of up to 192 MHz for OFDM channels in the downstream path and 96 MHz for Orthogonal Frequency-Division Multiple Access (OFDMA) channels in the upstream path. Multiple channels can be aggregated, or concatenated, into wider logical channels to increase overall throughput. Conventionally, such channels can be used to carry data in regions of the spectrum already known to possess required modulation capabilities.

Network devices, whether associated with the service provider (e.g., CATV network devices, a Cable Modem Termination System (CMTS), etc.) or the consumer (e.g., a modem device), are designed to utilize a “known” or “established” region of frequency spectrum. A “roll-off” region of frequency spectrum (i.e., unestablished region, unknown region, etc.), which exists at the upper range of the established frequency spectrum, can also be utilized by network devices. For example, if the established frequency spectrum is between 0 GHz and 1.8 GHZ, the unestablished region can begin at 1.2 GHZ and may include frequencies such as 1.25 GHZ, 1.3 GHZ, etc.

However, network devices generally do not utilize the unestablished region of the frequency spectrum because of the differing capabilities of each endpoint device (e.g., modem device, etc.) and/or network device (e.g., CTMS, etc.). Specifically, as modem devices and network devices are not necessarily standardized, some endpoint devices may have modulation support for a particular portion of the unestablished region, while some other endpoint devices may lack modulation support for that same portion. To avoid service degradation, network service providers will refrain from utilizing a portion of the unestablished region until it is determined that some (or all) endpoint devices support that portion of the unestablished region.

This problem is exacerbated by difficulties inherent to evaluating the unestablished region of the frequency spectrum. Conventional methods, such as Profile Management Application (PMA), can identify candidate channels within the unestablished region based on the known capabilities of existing devices. However, such approaches require the general availability of frequency spectrum to have already been determined, and at least one channel to have already been identified within the region-both of which are prohibitively difficult to accomplish.

Accordingly, implementations of the present disclosure propose an approach to efficiently and effectively identify candidate channels within the unestablished region of frequency spectrum. In this manner, implementations described herein can substantially increase the throughput of existing networks. For example, a computing system can configure a candidate channel for a network node (e.g., a CMTS, etc.). The candidate channel can include a frequency band within an unestablished region of frequency spectrum with unknown modulation support. As described herein, “unknown modulation support” generally refers to the capability to perform modulation/demodulation at a frequency outside an upper design limit of an endpoint device. For example, if an endpoint device has an upper design limit for modulation of 1 GHz, a candidate channel with a frequency band from 1.1 GHz to 1.2 GHz would have unknown modulation support from the endpoint device.

It should be noted that, in alternate implementations, configuration of the channel can be performed in a reciprocal manner. For example, the endpoint device for which the channel is configured can be a CMTS, while the network node can be a modem and/or router device.

Signaling can be sent via the candidate channel to a number of different endpoint devices. For example, a sounding channel can be broadcast from the network node to the endpoint devices, and each sub-carrier of the sounding channel can be established with zero-bit loading. The endpoint devices can be configured to utilize the candidate channel by providing the devices with information that defines the candidate channel as a non-data sounding channel.

Once configured, the computing system can receive signal measurements for the candidate channel from each of the endpoint devices. Based on the signal measurements, the computing system can generate channel viability information that indicates whether the candidate channel is viable for each of the endpoint devices. For example, if the received signal measurements indicate that each of the endpoint devices can support a required level of modulation on the candidate channel, the channel viability information can indicate that the channel is viable for each of the endpoint devices. The computing system can identify the candidate channel as a viable channel based on the channel viability information. In such fashion, the computing system can analyze the unestablished region of the frequency spectrum to efficiently and accurately identify viable candidate channels, thus substantially increasing the throughput capacity of communication networks (e.g., wireless networks, wired networks (e.g., CATV networks), etc.).

Aspects of the present disclosure provide a number of technical effects and benefits. As one example technical effect and benefit, implementations of the present disclosure can substantially increase network capacity by enabling utilization of unestablished regions of the frequency spectrum that currently cannot be utilized. More specifically, network capacity is based at least in part on the available frequency spectrum, and an increase in the available frequency spectrum can correspondingly increase network capacity. As such, by efficiently and effectively analyzing the unestablished region of the frequency spectrum to identify valid channels, implementations of the present disclosure can substantially increase the network capacity of communications networks.

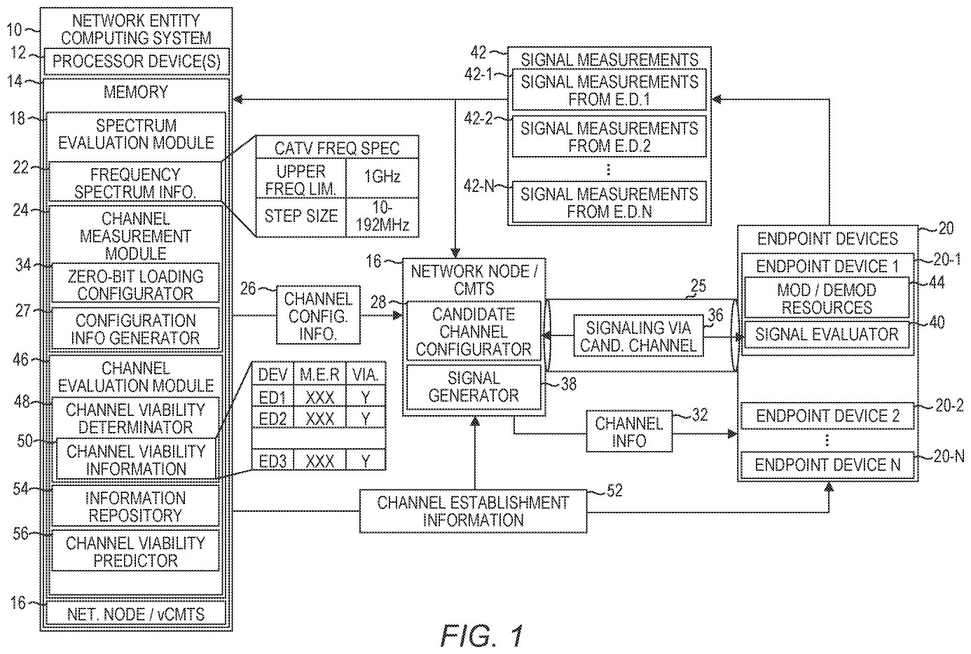

FIG. 1 is a block diagram of an environment suitable for implementing evaluation of unestablished regions of frequency spectrum to increase network throughput according to some implementations of the present disclosure. In some implementations, a network entity 10 includes processor device(s) 12 and memory 14. In some implementations, the network entity 10 may be a computing system that includes multiple computing devices. Alternatively, in some implementations, the network entity 10 may be one or more computing devices within a computing environment that includes multiple distributed devices and/or systems. Similarly, the processor device(s) 12 may include any computing or electronic device capable of executing software instructions to implement the functionality described herein.

To more clearly illustrate various implementations of the present disclosure, the network entity 10 is illustrated as a computing system and will be referred to interchangeably as both a computing system and network entity as described herein. However, the network entity 10 can be, or otherwise include, a variety of computing device(s) and/or network-specific device(s). Specifically, in some implementations, the network entity 10 can be, or otherwise include, a network node 16. The network node 16 can perform various functions, and can include or otherwise implement various network functions. For example, the network node 16 may be or otherwise include a Cable Modem Termination System (CMTS) (e.g., as a virtualized device, as a collection of hardware resources, as a specific CMTS device, etc.).

Alternatively, in some implementations, the network entity 10 can be a computing device or system that is communicatively coupled to the network node 16 (e.g., via existing wired or wireless network infrastructure). More specifically, in some implementations, the network entity 10 can be a distributed network of computing device(s) and/or system(s) that collectively implement various wireless networking services of an Internet Service Provider (ISP).

The memory 14 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 14 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

The memory 14 can include a spectrum evaluation module 18. The spectrum evaluation module 18 can perform or implement various functions that collectively explore unknown, or unexplored, regions of frequency spectrum within a network environment. Specifically, certain communication standards, such as DOCSIS 3.1, enables the use of multiple channels of particular widths (e.g., OFDM channels up to 192 MHz wide) in the downstream path and the upstream path (e.g., OFDMA channels up to 96 MHz wide), which can then be concatenated into even wider logical channels. Such channels can be configured within a “known” or “established” region of frequency spectrum. As used herein, “frequency spectrum” can refer to a spectrum of frequencies over which communications can be exchanged (e.g., wireless frequency spectrum, cable frequency spectrum, etc.). A “known” or “established” region of frequency spectrum can refer to regions of the spectrum already known to support a required level of modulation, such as 4K-QAM or lower. More specifically, an established region of frequency spectrum is known to be supported by most, or all, endpoint devices utilized within the network (e.g., modems, etc.).

Substantial portions of unused frequency spectrum exist outside of the established spectrum. These regions, which are referred to as “unknown” or “unestablished” regions of the frequency spectrum, are generally located in the “upper end” of the spectrum, especially within the area known as the “roll-off” region of the spectrum. The “roll-off” region, as referred to herein, refers to a region of frequency spectrum bounded by the upper design limit of the endpoint devices utilized within the network. For example, if some, or all, of the endpoint devices of a network have an upper limit of 1 GHz, the “roll-off” region is likely located around 1 GHz. When utilizing regions of the spectrum that are higher than the upper design limits of the endpoint devices, various components of the devices (e.g., amplifiers, taps, splitters, etc.) begin to severely degrade in their ability to support communications.

However, not all channels configured within the unestablished region of frequency spectrum necessarily cause performance degradation. To follow the previous example, if the upper limit of endpoint devices is 1 GHz, the devices may still support channels established between 1 GHz and 1.2 GHz. However, such channels must be identified and specifically evaluated for the endpoint devices utilized within the network before being implemented within communication networks.

As such, the spectrum evaluation module 18 can be leveraged to identify and evaluate candidate channels within the unestablished region of frequency spectrum of communication networks. Specifically, the spectrum evaluation module 18 can evaluate candidate channel performance for endpoint devices 20-1-20-N (generally, endpoint devices 20) that are served by the network entity 10, and/or the network node 16. The endpoint devices 20 can be physical, and/or virtual, devices that connect to and exchange information within a communications network. Examples of endpoint devices include modems, routers, modem/routers, network devices, etc. In some implementations, the endpoint devices 20 can be a particular set, or grouping, of endpoint devices assigned for spectrum exploration. For example, the endpoint devices 20 can each belong to the same service group of cable modems. For another example, the endpoint devices 20 can be a representative grouping of modem devices that includes each model of modem utilized within the network.

To identify and evaluate candidate channels, the spectrum evaluation module 18 can include frequency spectrum information 22. The frequency spectrum information 22 can indicate an upper frequency limit of the endpoint devices 20. For example, if the endpoint devices 20 have an average upper frequency limit of 1 GHZ, the frequency spectrum information 22 can indicate an upper frequency limit of 1 GHz. Alternatively, if one, or a subset, of the endpoint devices 20 has an upper limit of 1 GHz, while another subset of the endpoint devices 20 has an upper limit of 2 GHZ, the frequency spectrum information 22 can indicate an upper frequency of 1 GHz to ensure that all endpoint devices can utilize particular regions of the spectrum.

The spectrum evaluation module 18 can include a channel measurement module 24. The channel measurement module 24 can configure, or cause configuration of, a candidate channel 25 for evaluation. The channel measurement module 24 can also configure, or cause configuration of, the endpoint devices 20 to transmit signaling via the candidate channel 25 for evaluation. It should be noted that, as described herein, the candidate channel 25 may also be referred to as a “sounding” channel.

To do so, the channel measurement module 24 can generate channel configuration information 26 using a configuration information generator 27. The channel configuration information 26 can indicate the parameters by which the candidate channel 25 is to be configured. In some implementations, the channel configuration information 26 can include information indicating parameters for establishing the candidate channel within an unestablished region of frequency spectrum. For example, if the unestablished region of frequency spectrum begins at 1.0 GHz, the channel configuration information 26 can indicate a channel width of 50 MHz between 1.0 GHz and 1.05 GHz for the candidate channel 25.

In particular, the candidate channel 25 can be a candidate channel with a frequency band within an unestablished region of frequency spectrum with unknown modulation support from endpoint devices. As described herein, “unknown modulation support” generally refers to the capability to perform modulation/demodulation at a frequency outside an upper design limit of an endpoint device. For example, if an endpoint device has an upper design limit for modulation of 1 GHz, a candidate channel with a frequency band from 1.1 GHz to 1.2 GHz would have unknown modulation support from the endpoint device.

In some implementations, the network node 16 can be a network node separate from the network entity 10. Alternatively, in some implementations, the network node 16 can be, be included in, or otherwise be implemented by the network entity 10. The channel measurement module 24 can send the channel configuration information 26 to the network node 16. The network node 16 can include a candidate channel configurator 28. The candidate channel configurator 28 can establish the candidate channel 25 in accordance with the channel configuration information 26.

To do so, the network node 16 can provide channel information 32 indicative of the candidate channel 25 (e.g., the channel configuration information 26) to the endpoint devices 20. The channel information 32 can include some, or all, of the information utilized by the candidate channel configurator 28 to establish the candidate channel 25. Additionally, the channel information 32 can include instructions that instruct the endpoint devices 20 to exchange signaling via the candidate channel 25. The instructions can instruct the endpoint devices 20 to perform signal measurements for the signaling exchanged via the candidate channel 25. The instructions can instruct the endpoint devices 20 to report the signal measurements to the network node 16 and/or the network entity 10.

In some implementations, the channel measurement module 24 can include a zero-bit loading configurator 34. The zero-bit loading configurator 34 can configure the candidate channel 25 as a zero-bit loaded channel. A “zero-bit loaded” channel, as described herein, refers to a channel that is set to have zero-bit loading for each sub-carrier within the channel. When operating with zero-bit loading per sub-carrier, the sounding channel cannot carry data. By ensuring that no data is carried while evaluating an unknown region of frequency spectrum, and an accurate assessment of the available capacity can be empirically determined based on signal measurements, such as Modulation Error Ratio (MER) statistics, for each channel used in the evaluation.

As an example, assume that the network node 16 is a CMTS or virtual CMTS (vCMTS) implemented by the network entity 10. The zero-bit loading configurator 34 can generate the channel configuration information 26 indicative of a standard data channel (e.g., within the established region of spectrum, etc.) and a zero-bit loading channel. The zero-bit loading configurator 34 can send the channel configuration information 26 to the network node 16. The network node 16 can configure candidate channel 25 as the zero-bit loading channel. The network node 16 can transmit the channel information 32 to the endpoint devices 20. The channel information 32 can define the data channel and the zero-bit loading channel. The channel information 32 can also include the instructions for the endpoint devices 20 to transmit and measure signaling via the candidate channel 25. Alternatively, in some implementations, the endpoint device is a CMTS or vCMTS, the network node can be a modem and/or router device.

Once the candidate channel 25 is configured, the network node 16 can generate signaling 36 with a signaling generator 38. The network node 16 can exchange the signaling 36 with the endpoint devices 20 via the candidate channel 25. Specifically, each of the endpoint devices 20 can exchange the signaling 36 with the network node 16. The endpoint devices 20 can each include a signal evaluator 40. The signal evaluator 40 can perform measurements of the signaling 36 exchanged via the candidate channel 25 using the signal evaluator 40 to obtain signal measurements 42-1-42-N. Specifically, each of the endpoint devices 20-1-20-N can generate a corresponding signal measurement of the signal measurements 42-1-42-N.

In addition, each of the endpoint devices 20 can include modulation/demodulation resources 44. The modulation/demodulation resources 44 can be hardware and/or software resources utilized to modulate and/or demodulate the signaling 36 received via the candidate channel 25. In some network environments, the capabilities of available modulation/demodulation resources can vary between endpoint devices. These differences can be exacerbated when operating within an unestablished region of spectrum, and/or operating outside the upper design limits of the endpoint devices. For example, assume that the modulation/demodulation resources 44 of the endpoint device 20-1 and the endpoint device 20-2 both have an upper design limit of 1.1 GHz in the frequency spectrum. The modulation/demodulation resources 44 of the endpoint device 20-1 may actually be capable of modulating/demodulating signaling exchanged at up to 1.3 GHZ. However, the modulation/demodulation resources 44 of the endpoint device 20-2 may be incapable of modulating/demodulating the same signaling exchanged at up to 1.3 GHZ.

As such, the signal measurements 42 can exhibit substantial differences on a per-device basis. To follow the previous example, assume that the candidate channel 25 is configured with a frequency band between 1.25 GHz and 1.26 GHz. Because the modulation/demodulation resources 44 of the endpoint device 20-1 are sufficient for modulation/demodulation at that frequency band, the corresponding signal measurements 42-1 generated by the endpoint device 20-1 may indicate sufficient signal performance metrics. Conversely, because the modulation/demodulation resources 44 of the endpoint device 20-2 are not sufficient for modulation/demodulation at that frequency band, the corresponding signal measurements 42-2 generated by the endpoint device 20-2 may indicate insufficient signal performance metrics.

The signal measurements 42 can be transmitted to the network node 16 and/or the network entity 10. In some implementations, the network node 16 can receive the signal measurements 42 and process the signal measurements 42. Additionally, or alternatively, in some implementations, the network node 16 can pass the signal measurements 42 to the network entity 10. Additionally, or alternatively, in some implementations, the network entity 10 can receive the signal measurements 42 from the endpoint devices directly.

The spectrum evaluation module 18 can include a channel evaluation module 46. The channel evaluation module 46 can evaluate the signal measurements 42 to identify the candidate channel 25 as being a viable channel or a non-viable channel. To do so, the channel evaluation module 46 can include a channel viability determinator 48. The channel viability determinator 48 can measure each of the signal measurements 42 to generate channel viability information 50. The channel viability information 50 can indicate, for each of the endpoint devices 20, whether the modulation/demodulation capabilities of the devices are sufficient to exchange signaling via the candidate channel 25. To follow the previous example, the channel viability information 50 may indicate that the modulation/demodulation capabilities of the endpoint device 20-1 are sufficient, and that the modulation/demodulation capabilities of the endpoint device 20-2 are not sufficient.

The spectrum evaluation module 18 can generate channel establishment information 52. The channel establishment information 52 can identify the candidate channel 25 as a viable channel based on the signal measurements 42. For example, if the channel viability information 50 indicates that the candidate channel 25 is viable for each of the endpoint devices 20, the channel establishment information 52 can establish the candidate channel 25 as a viable channel. For another example, if the channel viability information 50 indicates that the candidate channel 25 is viable for a percentage of the endpoint devices 20 greater than a threshold percentage (e.g., 90% of the devices or more), the channel establishment information 52 can establish the candidate channel 25 as a viable channel. The network entity 10 can provide the channel establishment information 52 to the network node 16 and the endpoint devices 20 (e.g., either directly or indirectly through the network node 16).

In particular, by establishing the candidate channel 25 as a viable channel, the candidate channel 25 can be considered an “established” channel that includes a frequency band within an established region of the frequency spectrum. In other words, by identifying the candidate channel 25 as a viable channel, the network entity 10 can identify the corresponding portion of the frequency spectrum utilized by the candidate channel 25 as being included in the established region of the frequency spectrum. As such, upon obtaining the channel establishment information 52, the network node 16 can store information that identifies the candidate channel 25 as being an established channel with a frequency band within the established region of frequency spectrum.

Similarly, the endpoint devices 20 can, upon receipt of the channel establishment information 52, can store information that identifies the candidate channel 25 as being an established channel with a frequency band within the established region of frequency spectrum. In such fashion, the network entity 10 can accurately and efficiently identify a viable, established channel within an unestablished region of frequency spectrum, thus increasing the overall network capacity.

In some implementations, the channel evaluation module 46 can include an information repository 54. The information repository 54 can store the signal measurements 42, the channel establishment information 52, the channel configuration information 26, and any other information obtained for the candidate channel 25 and any previous and/or subsequent candidate channels. The channel evaluation module 46 can also include a channel viability predictor 56. The channel viability predictor 56 can predict whether a candidate channel will be viable based on the information stored in the information repository 54.

Specifically, in some implementations, the channel viability predictor 56 can be or otherwise include a machine-learned model trained to predict whether a candidate channel will be viable. For example, assume the machine-learned model has been trained on past examples of the channel configuration information 26 and the channel establishment information 52. The network entity 10 can process the channel configuration information 26 with the machine-learned model to obtain a model output indicating whether the candidate channel is viable. The network entity 10 can then train the model by evaluating the model output with a loss function while utilizing the channel establishment information 52 as a ground truth example. In some implementations, once trained, the channel viability predictor 56 can utilize the model to evaluate future candidate channels without receiving signal measurements for the candidate channel from the endpoint devices 20.

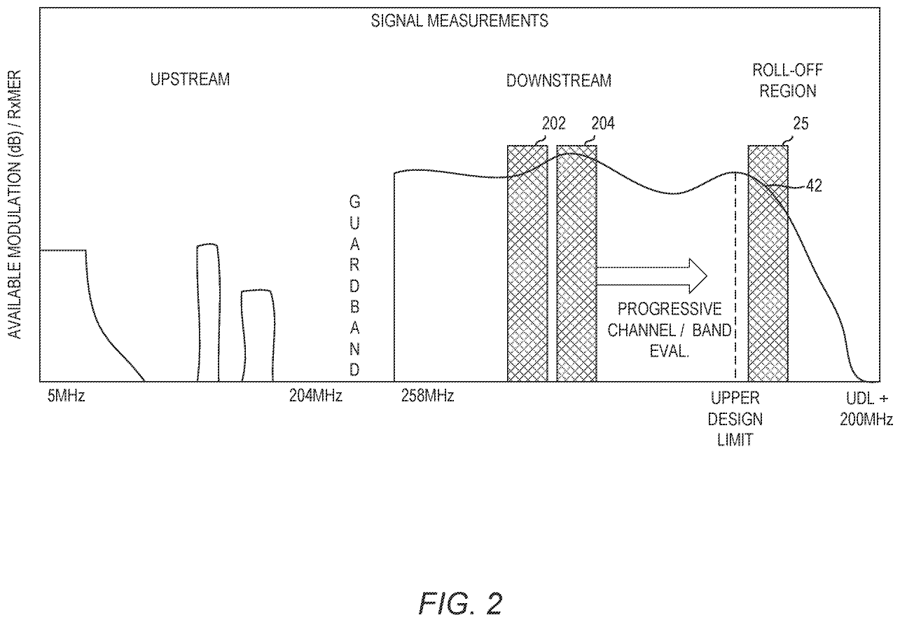

FIG. 2 illustrates example signal measurement information according to some implementations of the present disclosure. FIG. 2 will be discussed in conjunction with FIG. 1. In particular, FIG. 2 illustrates an example depiction of multiple signal measurements, including the signal measurements 42 of FIG. 1, generated by the endpoint devices 20 of FIG. 1 as zero-bit loaded channels are iteratively and progressively configured within a region of unexplored spectrum.

Channels 202 and 204 can be configured to evaluate regions (e.g., portions of the frequency spectrum) that exist relatively close to the upper design limit of the endpoint devices 20. For example, the channels 202 and 204 can represent 24-192 MHz wide channels positioned anywhere in the upstream and downstream bands, scanned for Receive Modulation Error Ratio (RxMER), then re-positioned one channel width higher and re-scanned until the spectrum region of interest has been completed. In other words, the network entity 10 can successively configure channels to fully explore the roll-off region as illustrated. At one point, the candidate channel 25 can be configured for evaluation. In some implementations, the channel width can vary based on the type of channel utilized. For example, if channels 202 and 204 are downstream channels (e.g., OFDM channels), the channel width may vary from 24 MHz to 192 MHz. For another example, if channels 202 and 204 are upstream channels (e.g., OFDMA channels), the channel width may vary from 6.4 MHz to 95 MHz.

As illustrated, the signal measurements 42 can measure the signal exchanged over the candidate channel 25 by the endpoint devices 20. In some implementations, the signal measurements 42 can be, or otherwise include, modulation error ratio (RxMER) measurements for the channel. For example, the signal measurements 42-1 can include RxMER measurements measured by the endpoint device 20-1 for each sub-carrier within the candidate channel 25. Signal measurements 42-2 can also include RxMER measurements measured by the endpoint device 20-2 for each sub-carrier within the candidate channel 25. In this manner, the signal measurements 42 can collectively account for differences between the capabilities of the different endpoint devices 20.

The signal measurements 42 can be measured in either or both the upstream and downstream bands. For example, an OFDMA channel may be utilized to measure an upstream band while an OFDM channel may be utilized to measure a downstream band. For either band, the RxMER can be evaluated at a particular resolution, such as 25 kHz or 50 kHz resolution. Any RF impairment in the candidate channel 25 can reduce the available RxMER by a number of decibels. This impairment, also referred to as a spectrum constraint, can be accounted for by the network entity 10 when evaluating the signal measurements.

In some implementations, the candidate channel 25 can be configured on the CMTS or vCMTS initially set to be positioned at the start frequency of the region of interest (e.g., the unestablished region). The candidate channel 25 can be broadcast to a service group of cable modems (e.g., endpoint devices 20). The candidate channel 25 can be set to have zero-bit loading for each sub-carrier. Each modem can be provided with a channel definition that includes the normal data channel but also adds a definition for this non-data, sounding channel. The candidate channel 25 can then operate with zero-bit loading per sub-carrier (i.e., is unable to map or otherwise carry data on a sub-carrier).

After each modem has acquired the candidate channel 25, each modem can be requested by the network entity to return a file containing the received modulation error ratio for each sub-carrier within the sounding channel. In the case of an upstream channel, the network entity can perform the same process except that the CMTS or vCMTS is requested to return the received modulation error ratio file for all modems in the service group. In other words, when measuring downstream the endpoint devices can generate and return signal measurements for signals transmitted to the devices by the network node, and while measuring downstream, the network node can generate and return signal measurements for signals transmitted to the node by the endpoint devices. In some implementations, the files can be analyzed to determine which modulations could be used to reach each modem with an active data channel. In some implementations, a candidate channel can be removed from the system and re-initialized at a second location higher or lower in the spectrum until the entire region of interest has been scanned in sequence and completed. For example, assume that signal measurements are collected for the candidate channel 202. The candidate channel 202 can be removed from the system and re-initialized as candidate channel 204 at a higher point in the frequency spectrum. In this manner, a “map” of the unestablished region of the frequency spectrum can be determined based on the available channel width, which may be 192 MHZ, 96 MHz, or some lower value as applicable to the available system choices.

In such fashion, the network entity can perform distributed evaluation of unestablished frequency spectrum to increase network capacity by identifying additional viable channels. In addition, the illustrated technique can enable an automated approach to spectrum quality measurements. This technique can be used on any type or manner of network node, such as a node containing DOCSIS 3.1 or higher standard modems, to obtain spectral plots or information. A major benefit is that it replaces the need for full-band capture and provides a much greater level of resolution. Implementations described herein also provide a more accurate measure of “useful” RxMER, rather than just providing the signal power level of the currently used spectrum. Being restricted to measuring signal power levels is a limitation that exists with Spectrum Analyzers, and the Full-Band-Capture Spectrum Analysis methods. However, implementations of the present disclosure enable the collection of more valuable information that can provide a network operator with direct knowledge of which modulation would be viable at each modem endpoint, for every endpoint location. This in turn allows for a direct estimation of the available capacity per modem in Mbps, and when extrapolated, provides a prediction for the total capacity a node will need to support, based on the aggregate of individual modem potential capacities.

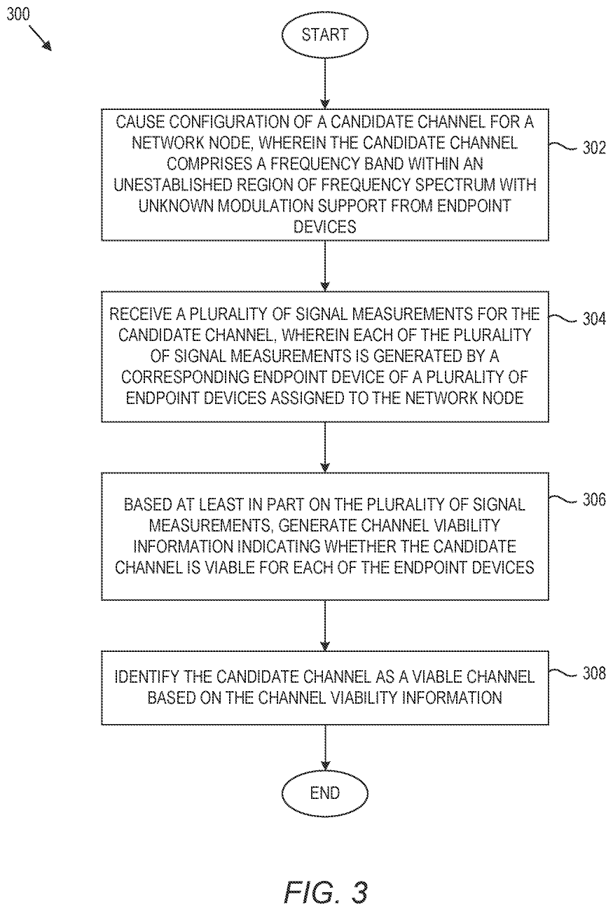

FIG. 3 is a flowchart of a method 300 for distributed evaluation of unestablished frequency spectrum for optimizing network capacity according to some implementations of the present disclosure.

At 302, a computing system, such as the network entity 10, can cause configuration of a candidate channel for a network node. For example, if the network node is accessible to the computing system, or is included in the computing system, the computing system can directly configure the network node with the candidate channel. To directly configure the computing system, the computing system can provide the network node with the frequency band and configuration of the channel to be configured, in addition to any other actions necessary for configuration of the network node. Alternatively, the computing system can indirectly configure the network node via an intermediary network entity (e.g., another network node, a central system, etc.).

The candidate channel can include a frequency band within an unestablished region of frequency spectrum with unknown modulation support from endpoint devices. As described herein, “unknown modulation support” generally refers to the capability to perform modulation/demodulation at a frequency outside an upper design limit of an endpoint device.

At 304, the computing system can receive a plurality of signal measurements for the candidate channel. Each of the plurality of signal measurements can be generated by a corresponding endpoint device of a plurality of endpoint devices assigned to the network node. For example, if 5 endpoint devices exchange signaling via the candidate channel, the network entity can receive 5 respective signal measurement files.

In some implementations, the signal measurements can be, or otherwise include, RxMER measurements. To follow the previous example, assume that the candidate channel includes 1000 subcarriers. Each of the 5 signal measurement files can include RxMER measurements for each of the 1000 subcarriers. Additionally, or alternatively, in some implementations, the signal measurements can include some other type or manner of signal measurement.

In some implementations, to receive the signal measurements, the computing system can provide instructions to the network node. The instructions can instruct the network node to transmit signaling to the endpoint devices via the candidate channel. The computing system can receive the plurality of signal measurements from the network node, and the signal measurements can be or otherwise include measurements of the signaling transmitted to the endpoint devices from the network node.

In some implementations, the computing system can cause configuration of the candidate channel for the network node by providing channel configuration information indicative of the candidate channel to the network node.

At 306, the computing system can generate channel viability information. The channel viability information can indicate whether the candidate channel is viable for each of the endpoint devices. It should be noted that a candidate channel can be considered “viable” for a particular endpoint device if the modulation/demodulation capabilities of the endpoint device are sufficient for utilizing the channel. The viability of an endpoint device can be determined based on the signal measurements received from the endpoint device. Additionally, or alternatively, in some implementations, the computing system can determine viable stop and start frequencies within the unestablished channel, rather than processing collected measurements to determine viability.

In some implementations, the channel viability information indicates whether a modulation capability of a first endpoint device of the plurality of endpoint devices is sufficient for the candidate channel.

In some implementations, to generate the channel viability information, the computing system can process the channel viability information with a machine-learned channel evaluation model to obtain the channel viability information, wherein the channel viability information is indicative of an aggregate viability of the candidate channel for the plurality of endpoint devices. In some implementations, the computing system can train the machine-learned channel evaluation model based on an optimization function that evaluates the channel viability information. For example, the computing system can evaluate an optimization function that evaluates a difference between the channel viability information and ground-truth viability information. The computing system can adjust values of parameters of the machine-learned channel evaluation model based at least in part on the optimization function.

At 308, the computing system can identify the candidate channel as a viable channel based on the channel viability information. The candidate channel can be identified as a viable channel based on the percentage of endpoint devices for which the candidate channel is viable. For example, if the candidate channel is viable for a small portion of the endpoint devices, the computing system is likely to identify the candidate channel as unviable. For another example, if the candidate channel is viable for all, or most, of the endpoint devices, the computing system is likely to identify the candidate channel as viable.

In some implementations, the computing system can provide channel establishment information to the network node. The channel establishment information can define the candidate channel as an established channel that includes a frequency band within the established region of the frequency spectrum. For example, assume that the network node is configured with a plurality of established channels that each include a frequency band within the established region of frequency spectrum. Upon receipt of the channel establishment information, the network node can be configured such that the candidate channel is included in the plurality of established channels. In this manner, portions of the unestablished region of the frequency spectrum can iteratively be added to the established region of the frequency spectrum.

In some implementations, the computing system can cause configuration of a second candidate channel for the network node. The second candidate channel can include a second frequency band, and the second frequency band can be subsequent to the frequency band of the candidate channel within the unestablished region of the frequency spectrum. The computing system can receive a plurality of second signal measurements for the second candidate channel. Each of the plurality of second signal measurements is generated by a corresponding endpoint device of the plurality of endpoint devices assigned to the network node. Based at least in part on the plurality of second signal measurements, the computing system can generate second channel viability information indicative of a viability of the second candidate channel for each of the endpoint devices. The computing system can identify the second candidate channel as a non-viable channel based on the second channel viability information. In some implementations, the candidate channel can be, or otherwise include, a zero-bit loading channel.

In some implementations, the computing system can receive a plurality of second signal measurements for a second candidate channel. Each of the plurality of second signal measurements can be generated by a corresponding endpoint device of the plurality of endpoint devices assigned to the network node. The computing system can process the plurality of second signal measurements with the machine-learned channel evaluation model to obtain second channel viability information indicative of an aggregate viability of the second candidate channel for the plurality of endpoint devices.

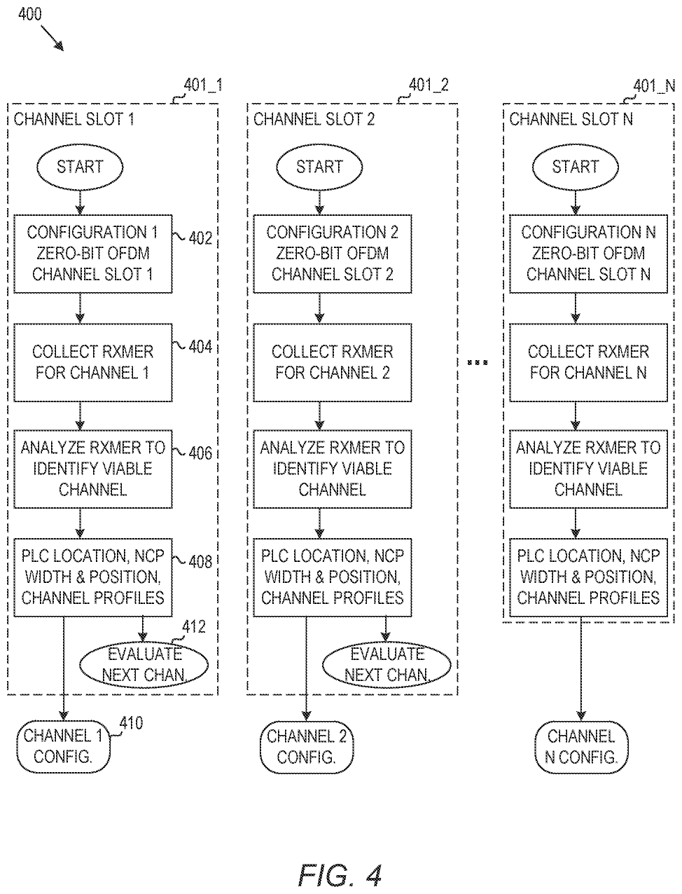

FIG. 4 is a flowchart for a method 400 for sequentially evaluating portions of an unestablished region of frequency spectrum to fully evaluate the unestablished region of frequency spectrum according to some implementations of the present disclosure.

More specifically, to fully evaluate the unestablished region of frequency spectrum, the computing system can perform spectrum evaluation iterations across all possible N channel slots. In this manner, the network node can construct a complete view of the frequency spectrum and associated metrics.

As depicted, the network node can start to perform the N spectrum evaluation iterations by first performing a first spectrum evaluation iteration 401_1. To perform the first spectrum evaluation iteration 401_1, the network node can do the following:
At 402, the network node (e.g., network computing system, physical network device, network microservice, network virtual device, etc.) can configure a zero-bit OFDM channel 1.
At 404, the network node can collect RxMER measurements for the channel 1.
At 406, the network node can analyze the RxMER measurements to identify the channel 1 as a viable channel. In some implementations, the network node can leverage some manner of analysis technique or system to perform the analysis. For example, the network node can process the RxMER measurements with a machine-learned model trained to determine whether the candidate channel is viable. For another example, the network node can process the RxMER measurements with a statistical or analytical engine.
At 408, in some implementations, the network node can generate an additional output that indicates suitable locations for the Physical Link Channel (PLC) and Next-Code-Word Pointer (NCP) to be placed when the channel is established. In this manner, the network entity can more efficiently establish the candidate channel as an established channel (i.e., an operational data-carrying channel) within an established region of the frequency spectrum.
At 410, the network node can store the PLC and NCP locations, and any other information related to the candidate channel, as a channel configuration file.
At 412, the network node can continue to perform the subsequent spectrum evaluation iteration.

The network node can then continue to perform such iterations until evaluating the final portion of the frequency spectrum with spectrum evaluation iteration 401_N. In this fashion, the network node can perform spectrum evaluation iterations across all possible N channel slots to fully evaluate the unestablished region of the frequency spectrum.

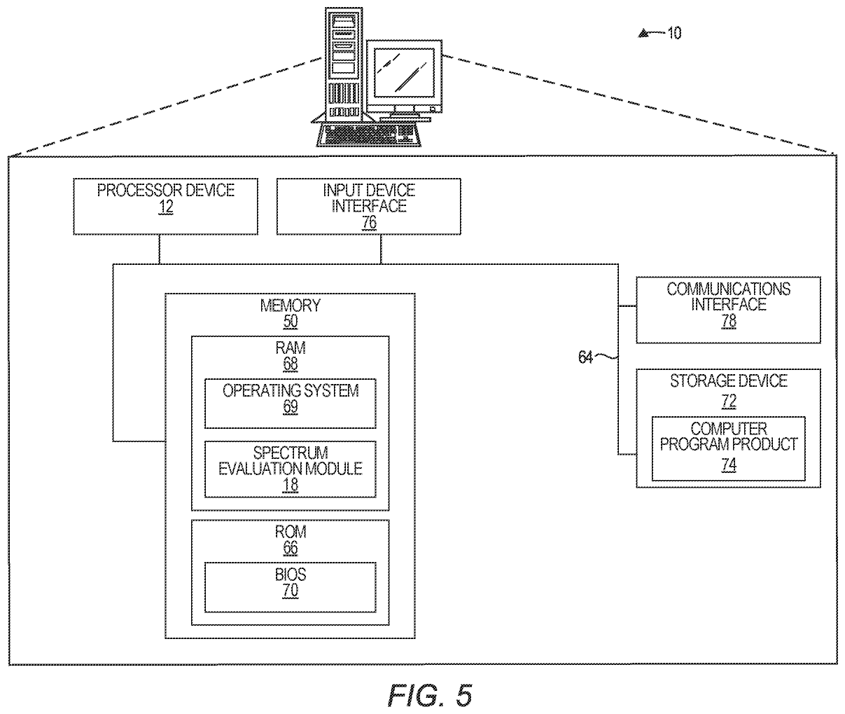

FIG. 5 is a block diagram of the network entity 10 suitable for implementing examples according to one implementation. The network entity 10 may comprise any computing or electronic device capable of including firmware, hardware, and/or executing software instructions to implement the functionality described herein, such as a computer server, a desktop computing device, a laptop computing device, a smartphone, a computing tablet, or the like. The network entity 10 includes the processor device(s) 12, the memory 14, and a system bus 64. The system bus 64 provides an interface for system components including, but not limited to, the memory 14 and the processor device(s) 12. The processor device(s) 12 can be any commercially available or proprietary processor.

The system bus 64 may be any of several types of bus structures that may further interconnect to a memory bus (with or without a memory controller), a peripheral bus, and/or a local bus using any of a variety of commercially available bus architectures. The memory 14 may include non-volatile memory 66 (e.g., read-only memory (ROM), erasable programmable read-only memory (EPROM), electrically erasable programmable read-only memory (EEPROM), etc.), and volatile memory 68 (e.g., random-access memory (RAM)). A basic input/output system (BIOS) 70 may be stored in the non-volatile memory 66 and can include the basic routines that help to transfer information between elements within the network entity 10. The volatile memory 68 may also include a high-speed RAM, such as static RAM, for caching data.

The network entity 10 may further include or be coupled to a non-transitory computer-readable storage medium such as the storage device 72, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 72 and other drives associated with computer-readable media and computer-usable media may provide non-volatile storage of data, data structures, computer-executable instructions, and the like.

A number of modules can be stored in the storage device 72 and in the volatile memory 68, including an operating system 69 and one or more program modules, such as the spectrum evaluation module 18, which may implement the functionality described herein in whole or in part. All or a portion of the examples may be implemented as a computer program product 74 stored on a transitory or non-transitory computer-usable or computer-readable storage medium, such as the storage device 72, which includes complex programming instructions, such as complex computer-readable program code, to cause the processor device(s) 12 to carry out the steps described herein. Thus, the computer-readable program code can comprise software instructions for implementing the functionality of the examples described herein when executed on the processor device(s) 12. The processor device(s) 12, in conjunction with the spectrum evaluation module 18 in the volatile memory 68, may serve as a controller, or control system, for the network entity 10 that is to implement the functionality described herein.

Because the spectrum evaluation module 18 is a component of the network entity 10, functionality implemented by the spectrum evaluation module 18 may be attributed to the network entity 10 generally. Moreover, in examples where the spectrum evaluation module 18 comprises software instructions that program the processor device(s) 12 to carry out functionality discussed herein, functionality implemented by the spectrum evaluation module 18 may be attributed herein to the processor device(s) 12.

An operator, such as the user, may also be able to enter one or more configuration commands through a keyboard (not illustrated), a pointing device such as a mouse (not illustrated), or a touch-sensitive surface such as a display device. Such input devices may be connected to the processor device(s) 12 through an input device interface 76 that is coupled to the system bus 64 but can be connected by other interfaces such as a parallel port, an Institute of Electrical and Electronic Engineers (IEEE) 1394 serial port, a Universal Serial Bus (USB) port, an IR interface, and the like. The network entity 10 may also include the communications interface 78 suitable for communicating with the network as appropriate or desired. The network entity 10 may also include a video port configured to interface with a display device, or to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
causing, by a computing system comprising one or more processor devices, configuration of a candidate channel for a network node, wherein the candidate channel comprises a frequency band within an unestablished region of frequency spectrum with unknown modulation support from endpoint devices;
receiving, by the computing system, a plurality of signal measurements for the candidate channel, wherein each of the plurality of signal measurements is generated by a corresponding endpoint device of a plurality of endpoint devices assigned to the network node;
based at least in part on the plurality of signal measurements, generating, by the computing system, channel viability information indicating whether the candidate channel is viable for each of the endpoint devices; and
identifying, by the computing system, the candidate channel as a viable channel based on the channel viability information.

2. The method of claim 1, wherein the network node is configured with a plurality of established channels, each comprising a frequency band within an established region of the frequency spectrum; and
wherein the method further comprises:
providing, by the computing system, channel establishment information to the network node that defines the candidate channel as an established channel comprising a frequency band within the established region of the frequency spectrum.

3. The method of claim 1, wherein receiving the plurality of signal measurements for the candidate channel comprises:
providing, by the computing system to the network node, instructions to transmit signaling to the plurality of endpoint devices via the candidate channel; and
receiving, by the computing system, the plurality of signal measurements from the network node, wherein the plurality of signal measurements comprise measurements of the signaling transmitted to the endpoint devices from the network node.

4. The method of claim 3, wherein causing the configuration of the candidate channel for the network node comprises:
providing, by the computing system to the network node, channel configuration information indicative of the candidate channel.

5. The method of claim 1, wherein the method further comprises:
causing, by the computing system, configuration of a second candidate channel for the network node, wherein the second candidate channel comprises a second frequency band subsequent to the frequency band of the candidate channel within the unestablished region of the frequency spectrum.

6. The method of claim 5, wherein the method further comprises:
receiving, by the computing system, a plurality of second signal measurements for the second candidate channel, wherein each of the plurality of second signal measurements is generated by a corresponding endpoint device of the plurality of endpoint devices assigned to the network node;
based at least in part on the plurality of second signal measurements, generating, by the computing system, second channel viability information indicative of a viability of the second candidate channel for each of the endpoint devices; and
identifying, by the computing system, the second candidate channel as a non-viable channel based on the second channel viability information.

7. The method of claim 1, wherein the candidate channel comprises a zero-bit loading channel.

8. The method of claim 1, wherein each of the plurality of signal measurements comprises Modulation Error Ratio (MER) statistics for the candidate channel.

9. The method of claim 1, wherein generating the channel viability information comprises:
based at least in part on the plurality of signal measurements, generating, by the computing system, the channel viability information indicative of the viability of the candidate channel for each of the endpoint devices, wherein the channel viability information indicates whether a modulation capability of each endpoint device of the plurality of endpoint devices is sufficient for the candidate channel.

10. The method of claim 1, wherein generating the channel viability information comprises:
processing, by the computing system, the plurality of signal measurements with a machine-learned channel evaluation model to obtain the channel viability information, wherein the channel viability information is indicative of an aggregate viability of the candidate channel for the plurality of endpoint devices.

11. The method of claim 10, wherein the method further comprises:
training, by the computing system, the machine-learned channel evaluation model based on an optimization function that evaluates the channel viability information.

12. The method of claim 11, wherein training the machine-learned channel evaluation model based on the optimization function comprises:
evaluating, by the computing system, an optimization function that evaluates a difference between the channel viability information and ground-truth viability information; and
adjusting values of parameters of the machine-learned channel evaluation model based at least in part on the optimization function.

13. The method of claim 12, wherein the method further comprises:
receiving, by the computing system, a plurality of second signal measurements for a second candidate channel, wherein each of the plurality of second signal measurements is generated by a corresponding endpoint device of the plurality of endpoint devices assigned to the network node; and
processing, by the computing system, the plurality of second signal measurements with the machine-learned channel evaluation model to obtain second channel viability information indicative of an aggregate viability of the second candidate channel for the plurality of endpoint devices.

14. The method of claim 1, wherein the computing system comprises the network node; and
wherein the network node comprises a Cable Modem Termination System (CMTS).

15. A network node, comprising:
a memory; and
one or more processor devices coupled to the memory configured to:
configure a candidate channel that comprises a frequency band within an unestablished region of frequency spectrum with unknown modulation support from endpoint devices, wherein the network node is configured with a plurality of established channels, each comprising a frequency band within an established region of the frequency spectrum;
receive, from a plurality of endpoint devices assigned to the network node, a plurality of signal measurements for the candidate channel, wherein each of the plurality of signal measurements is generated by a corresponding endpoint device of the plurality of endpoint devices;
provide the plurality of signal measurements to a network computing system; and
responsive to providing the plurality of signal measurements, receive, from the network computing system, channel configuration information that defines the candidate channel as an established channel comprising a frequency band within the established region of the frequency spectrum.

16. The network node of claim 15, wherein, prior to configuring the candidate channel, the one or more processor devices are configured to:
receive, from the network computing system, channel establishment information that defines the candidate channel as an established channel comprising the frequency band within the established region of the frequency spectrum.

17. The network node of claim 15, wherein receiving the plurality of signal measurements for the candidate channel comprises:
receiving, from the network computing system, instructions to transmit signaling to the plurality of endpoint devices via the candidate channel;
transmitting signaling to the plurality of endpoint devices via the candidate channel; and
receiving each of the plurality of signal measurements from a corresponding endpoint device of the plurality of endpoint devices.

18. The network node of claim 15, wherein the candidate channel comprises a zero-bit loading channel.

19. The network node of claim 15, wherein the network node comprises a CMTS, and wherein each of the endpoint devices comprises a modem.

20. A non-transitory computer-readable storage medium that includes executable instructions configured to cause one or more processor devices of a computing system to:
cause configuration of a candidate channel for a network node, wherein the candidate channel comprises a frequency band within an unestablished region of frequency spectrum with unknown modulation support from endpoint devices;
receive a plurality of signal measurements for the candidate channel, wherein each of the plurality of signal measurements is generated by a corresponding endpoint device of a plurality of endpoint devices assigned to the network node;
based at least in part on the plurality of signal measurements, generate channel viability information indicating whether the candidate channel is viable for each of the endpoint devices; and
identify the candidate channel as a viable channel based on the channel viability information.
